(19) United States
(12) Patent Application Publication
(10) Pub. No.: US 2006/0044154 A1
(43) Pub. Date: Mar. 2, 2006

(54) Combination of remote control and manual control for a ceiling fan

(76) Inventor: Ying-Sheng Liao, LongJing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/929,393

(22) Filed: Aug. 31, 2004

(51) Int. Cl. G05B 23/02; G08C 19/00

(52) U.S. Cl. 340/825.72; 398/106

(57) ABSTRACT

A remote control for a ceiling fan includes a control group for emitting command signals and a manual control on a wall has a control group functionally correspondent to the control group on the remote control. A far-infrared device is received in the manual control so as to receive the command signals from the remote control and the signals are then passed to the motor unit of the ceiling fan to control the blades.

### FIELD OF THE INVENTION

The present invention relates to a combination of a remote control and manual control for a ceiling fan, wherein a far-infrared control device is installed in the manual control on wall so as to receive control command from a remote control.

### BACKGROUND OF THE INVENTION

As shown in FIG. 5, a conventional ceiling fan 30 is equipped with a far-infrared control device 211 which is connected to the motor unit 31 so as to control the movement of the blades 32. However, the ceiling fan 30 is connected to the ceiling so that the control commands coming from the remote control 10 tend to be interrupted by the blades when the user stands below the ceiling fan 30 and operate the remote control 10. Besides, the far-infrared device 211 is received in the motor unit 31 so that the whole ceiling fan assembly has to be disengaged from the ceiling when the far-infrared device 211 needs to be maintained. This spends a lot of time can could damage the motor unit.

The present invention provides a far-infrared control device installed in the manual control on the wall so that the user sends the commands toward the wall rather than the ceiling fan to control the ceiling fan.

### SUMMARY OF THE INVENTION

The present invention relates to a combination of a remote control and a manual control for a ceiling fan. The remote control has a control group which is functionally correspondent to a control group on the manual control. A far-infrared device is received in the manual control so as to receive command signals from the remote control and the signals are then passed to a motor unit of the ceiling fan.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the remote control and the manual control of a ceiling fan;

FIG. 2 is an exploded view to show the manual control of the ceiling fan;

FIG. 3 shows the user uses the remote control to send signals to the manual control;

FIG. 4 shows the earth line of the ceiling fan is connected to the wall, and

FIG. 5 shows a conventional ceiling fan controlled by using a remote control.

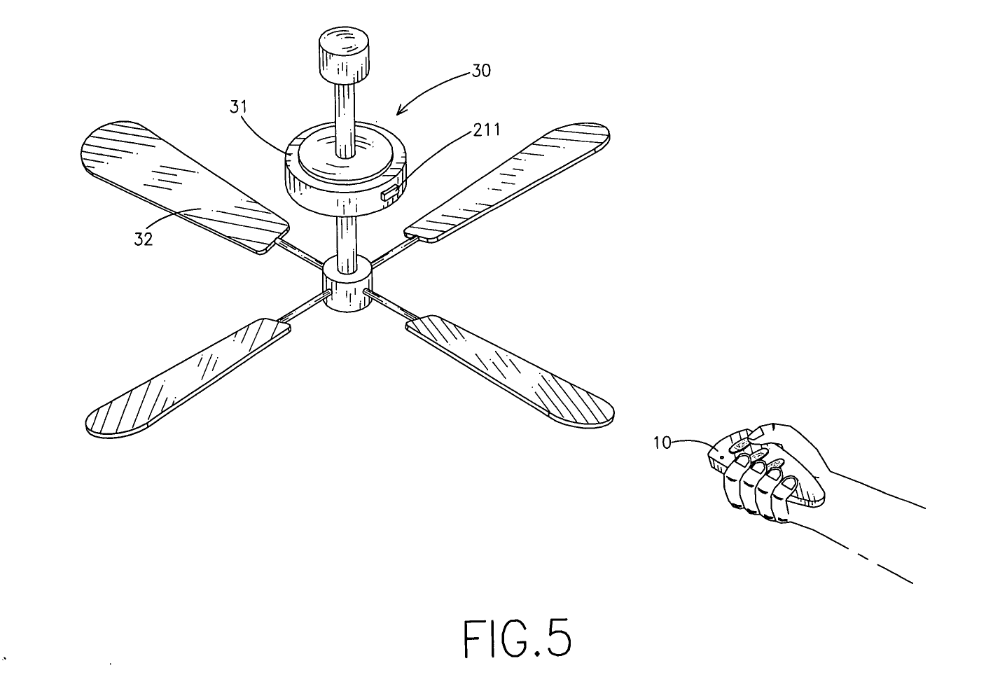

### DETAILED DESCRIPTION OF THE PREFERRED EMBODIMENT

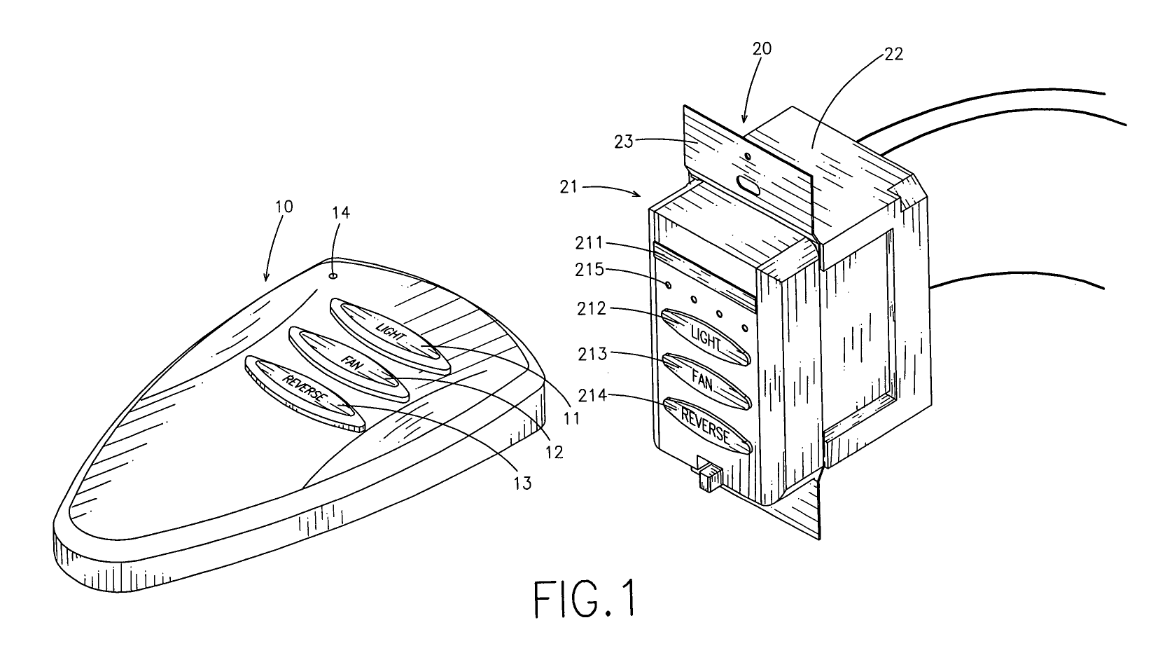

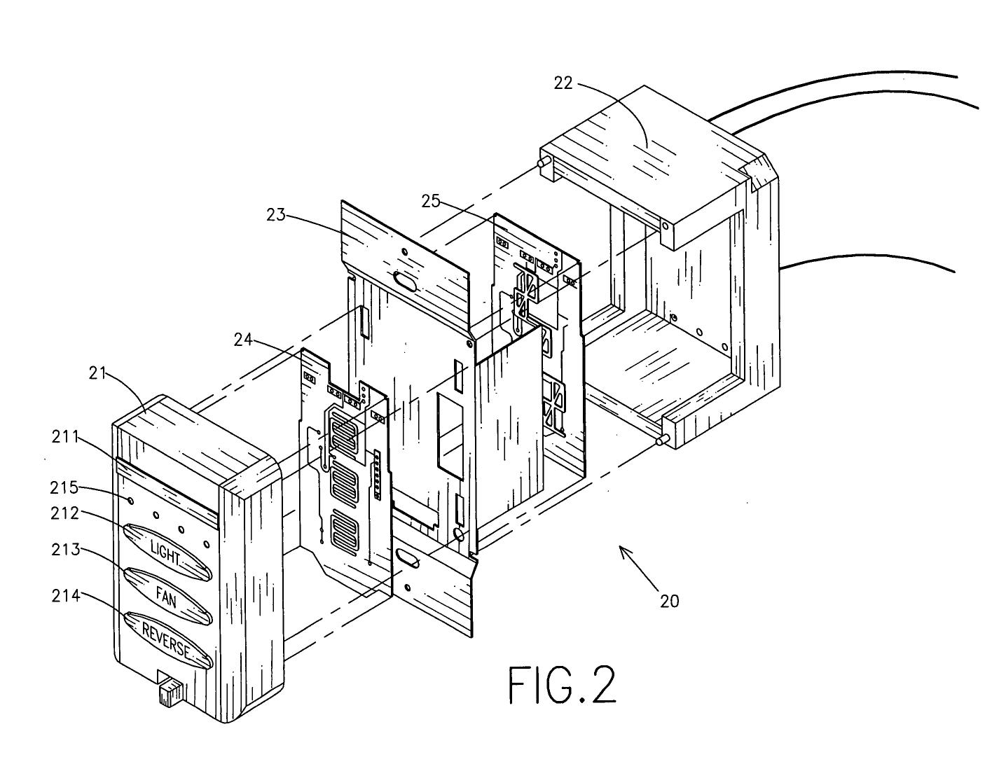

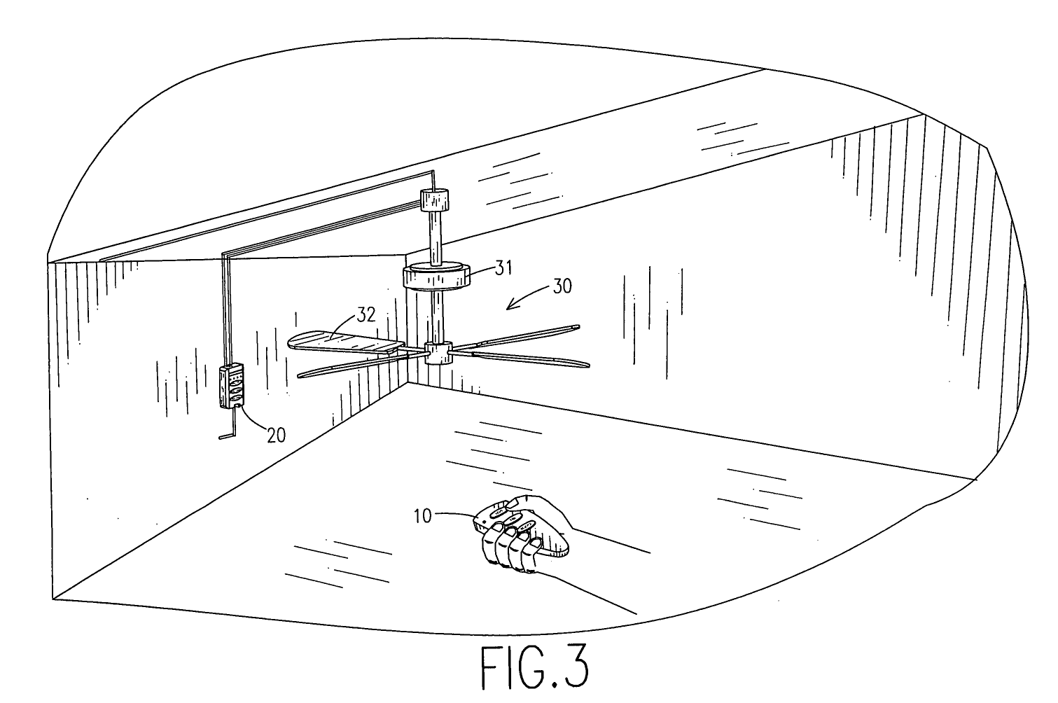

Referring to FIGS. 1 to 3, a ceiling fan 30 is controlled by using a remote control 10 and a manual control 20. The remote control 10 has a control group which includes a light control 11, a fan control 12, a reverse control 13 and a display light 14. The manual control 20 includes a control group which includes a light control 212, a fan control 213, a reverse control 214. The control group on the remote control 10 is functionally correspondent to the control group 212, 213, 214 on the manual control 20. The manual control 20 is connected to a wall by using a fixing piece 23 and a far-infrared device 211 is received in the manual control 20.

The manual control 20 includes a panel 21 connected to a base 22 and control members 24, 25 such as circuit boards are received in the base 22 so as to receive the command signals coming from the far-infrared device 211 and the control group 212, 213, 214 on the panel 21. A status display 215 is also connected to the panel 21.

The user uses the remote control 10 to emit command signals to the manual control 20 on the wall and the far-infrared device 211 receives the command signals and the command signals are passed to a motor unit 31 of the ceiling fan 30. The status of the operation of the ceiling fan 30 is displayed by the status display 215 on the panel 21.

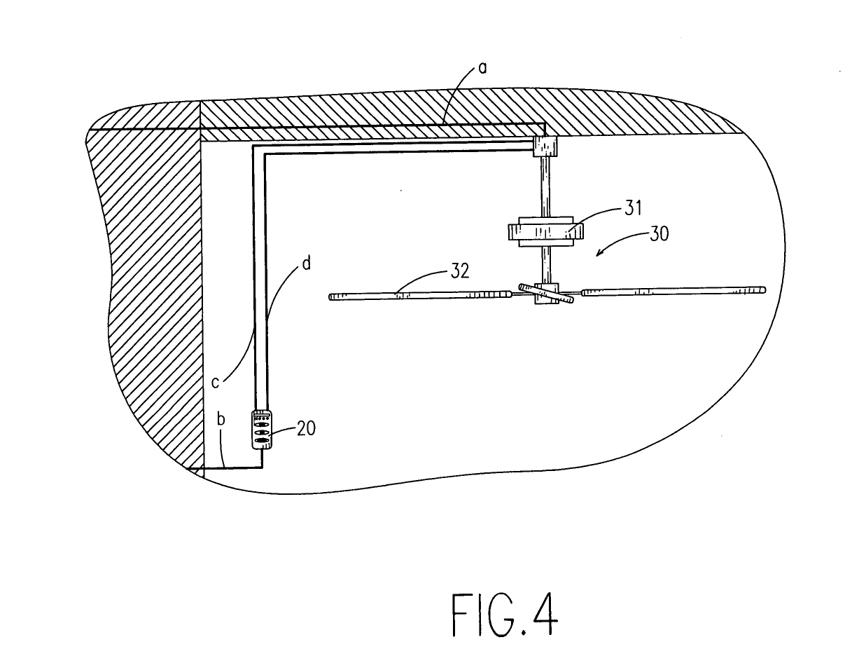

As shown in FIG. 4, some buildings do not include earth circuit so that the earth line “a” of the ceiling fan 30 is directly connected to a wall to complete the earth process. The circuit “c” of the light on the ceiling fan 30 and the circuit “d” of the motor are respectively connected to the control group 212, 213, 214 of the manual control 20. The manual control 20 is directly connected to the exist circuit “b” of the building and which does not need to be adjusted or changed. The earth line “a” of the ceiling fan 30 does not need to be connected to the manual control 20.

The present invention includes the following advantages:

1. The present invention combines the functions of the remote control and the manual control so that the command signals are not interrupted by the blades.

2. The command signals are received by the manual control so that the ceiling fan does not need to be disengaged from the ceiling during maintenance. The motor unit does not need to be disengaged and avoids from being damaged during disengaging from the ceiling fan. Maintenance only applies to the manual control.

While we have shown and described the embodiment in accordance with the present invention, it should be clear to those skilled in the art that further embodiments may be made without departing from the scope of the present invention.

What is claimed is:

1. A combination of a remote control (10) and a manual control (20) for a ceiling fan (30), wherein the remote control (10 having a control group (11, 12, 13) which is functionally correspondent to a control group (212, 213, 214) on the manual control (20), a far-infrared device (211) received in the manual control (20), the manual control (20) receiving command signals from the remote control (10) by the far-infrared device (211) and passing the command signals to a motor unit (31) of the ceiling fan (30).

2. The combination as claimed in claim 1, wherein the manual control (20) includes a panel (21) connected to a base (22) and control members (24, 25) are received in the base (22) so as to receive the command signals coming from the far-infrared device (211) and control group (212, 213, 214) on the panel (21).

3. The combination as claimed in claim 2, wherein an earth line (a) of the ceiling fan (30) is adapted to be connected to a wall.
